(19) United States
(12) Patent Application Publication
(10) Pub. No.: US 2016/0294090 A1
(43) Pub. Date: Oct. 6, 2016

(54) ELECTRICAL CONNECTOR

(71) Applicant: CviLux Corporation, New Taipei City (TW)

(72) Inventor: CHAO-CHUN YANG, Taipei City (TW)

(21) Appl. No.: 14/842,979

(22) Filed: Sep. 2, 2015

(30) Foreign Application Priority Data
Apr. 1, 2015 (TW) 104204928

(51) Int. Cl. H01R 12/77

(52) U.S. Cl. CPC H01R 12/77

(57) ABSTRACT

An electrical connector is provided. The electrical connector includes an insulating housing, an adaptor board, and a plurality of terminals. The insulating housing has a plurality of slots, a plurality of terminal holes, and an inserting recess. The terminal holes are formed on an inner sidewall of the inserting recess. The adaptor board disposed on the insulating housing includes a plurality of first conductive portions and a plurality of notches formed at one side of the adaptor board. The terminals are respectively accommodated in the slots of the insulating housing. Each of the terminals has an elastic portion and a contacting portion. Each of elastic portions of the terminals can be engaged with each of notches and electrically connected to each of the first conductive portions. The contacting portions of the terminals respectively pass through the terminal holes and protrude from the inner sidewall of the inserting recess.

### BACKGROUND OF THE INVENTION

1. Field of the Invention

The instant disclosure relates to an electrical connector, in particular, to an electrical connector for connecting a flex flat cable (FFC).

2. Description of Related Art

Advanced technology attachment (ATA) is implemented in the computer as an interface standard for the connection between storage devices, such as hard disk drives, and the motherboard. Two interface standards, parallel ATA (PATA) and serial ATA (SATA), have been developed.

To establish the electrical connections of hard disk drive or blue-ray optical disc drive, flexible transmitting units, such as flex flat cable (FFC) or flexible printed circuit (FPC), are currently used to connect the SATA connectors and electrically conductive interfaces.

Traditional SATA connector includes a plurality of terminals and a printed circuit board (PCB) for transferring signals, and the PCB usually has at least two sets of pads disposed thereon, which are electrically connected to each other. One of the two sets of pads is used to electrically connect terminals, and the other one is used to electrically connect a conductive portion of the flex flat cable. Currently, the solder pastes are usually formed on the PCB to serve as the solder pastes. An amount of each of the solder pastes should be enough to ensure a good electrical contact between each of the terminals and the corresponding pad. However, too large an amount of the solder paste may result in increasing the parasitic capacitance or the parasitic inductance, and thus impact the signal transmission. However, too little an amount of the solder paste may result in bad electrical contacts between the terminals and the PCB.

### SUMMARY OF THE INVENTION

The object of the instant disclosure is to provide an electrical connector, in which an adaptor board has a plurality of notches formed at one side of the adaptor board so that each of elastic portions of the terminals can be engaged with each of notches to fix the adaptor board. Additionally, each of contact pads is disposed at each of inner surfaces of the notches. When the elastic portions of the terminals respectively abut the inner surfaces of the notches, the terminals can be respectively in contact with the contact pads to establish the electrical connections.

In order to achieve the aforementioned objects, according to an embodiment of the present invention, an electrical connector is provided. The electrical connector includes an insulating housing, an adaptor board, and a plurality of terminals. The insulating housing has a plurality of slots and a plurality of terminal holes. In addition, the insulating house has an inserting recess, and the terminal holes are formed on an inner sidewall of the inserting recess. The adaptor board can be disposed on the insulating housing, and includes a plurality of first conductive portions and a plurality of notches formed at one side of the adaptor board. The terminals are respectively accommodated in the slots of the insulating housing. Each of the terminals has an elastic portion and a contacting portion. Each of elastic portions of the terminals can be engaged with each of notches and electrically connected to each of the first conductive portions. The contacting portions of the terminals respectively pass through the terminal holes and protrude from the inner sidewall of the inserting recess.

The advantages of the electrical connector provided in the instant disclosure are that the adaptor board of the electrical connector has a plurality of notches formed at one side of the adaptor board to respectively engage with the terminals, which helps the adaptor board to be fastened on the insulating housing. In addition, in an embodiment of the instant disclosure, the contact pads are respectively disposed at the inner surfaces of the notches. As such, the amount of the solder paste can be decreased to attenuate the impact on the signal transmission due to the parasitic capacitance or the parasitic inductance. In addition, under the conditions that the amount of solder pastes is decreased, good electrical connections between the terminals and the adaptor board still can be ensured.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a perspective exploded view of an electrical connector in accordance with an embodiment of the instant disclosure;

FIG. 2 shows an exploded view of the electrical connector viewed from another side in accordance with an embodiment of the instant disclosure;

FIG. 3 shows a schematic view of an electrical connector in accordance with one embodiment of the instant disclosure;

FIG. 4 shows a schematic view of an electrical connector viewed from another side in accordance with one embodiment of the instant disclosure;

FIG. 5 shows a partial schematic view of an electrical connector in accordance with one embodiment of the instant disclosure;

FIG. 6 shows a sectional view of an electrical connector in accordance with one embodiment of the instant disclosure;

FIG. 7 shows an enlarged view of portion A shown in FIG. 6 in accordance with one embodiment of the instant disclosure;

### DETAILED DESCRIPTION OF THE PREFERRED EMBODIMENTS

In the following description, numerous specific details of electrical connectors according to the embodiments of the instant disclosure are set forth in order to provide a thorough understanding of one or more aspects and/or features described herein. It will be apparent, to one skilled in the art, to readily understand the advantages and the effectiveness of the instant disclosure. Furthermore, the instant disclosure can also be implemented or applied by various other specific examples. The details in the following descriptions can also be modified or changed based on different perspectives and applications without departing from the spirit of the instant disclosure. In addition, the drawings as referred to throughout the description of the instant disclosure are for illustrative purpose only, but not drawn according to actual scale, i.e., the actual scale of the related structure is not illustrated. The relative techniques of the instant disclosure will be set forth through the following embodiments, but are not intended to limit the scope of the instant disclosure.

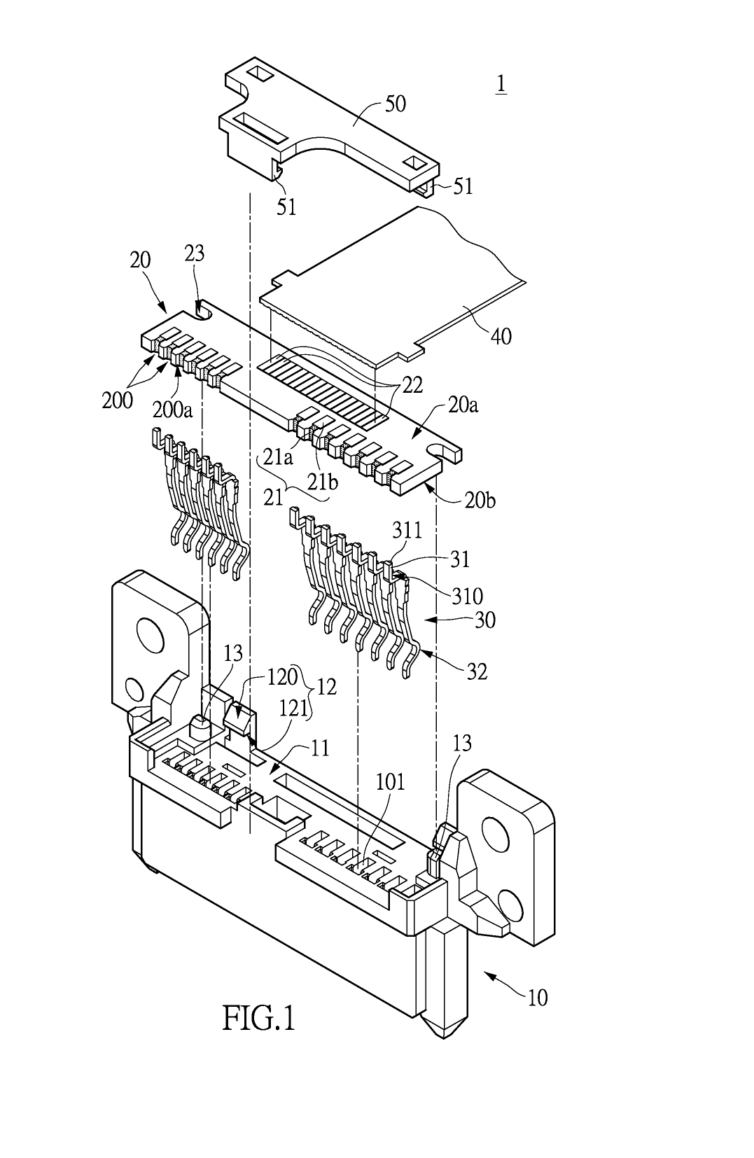

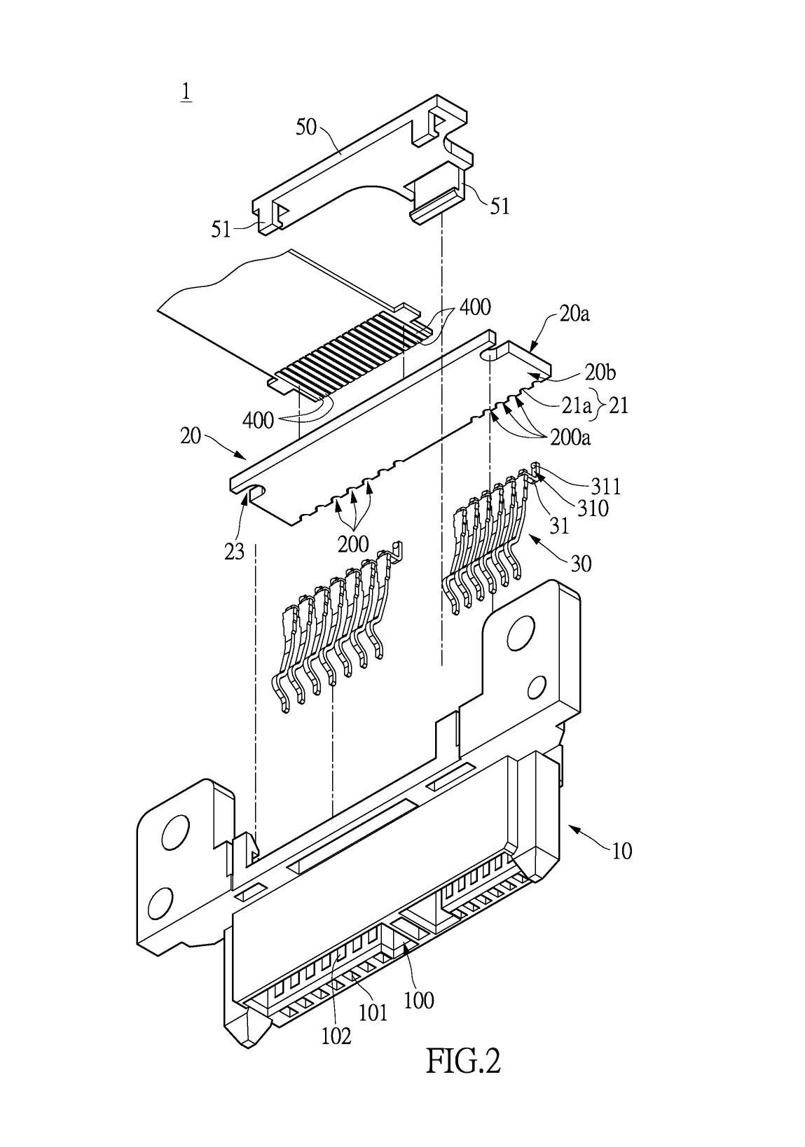

Please refer to FIG. 1 and FIG. 2. FIG. 1 shows a perspective exploded view of an electrical connector in accordance with an embodiment of the instant disclosure. FIG. 2 shows an exploded view of the electrical connector viewed from another side in accordance with an embodiment of the instant disclosure. The electrical connector 1 of the instant embodiment includes an insulating housing 10, an adaptor board 20, a plurality of terminals 30, cable 40, and cover 50.

The insulating housing 10 has a supporting surface 11, a plurality of slots 101, at least one inserting recess 100 (as shown in FIG. 2), and a plurality of terminal holes 102. Please refer to FIG. 1. The supporting surface can be used to support the adaptor board 20, and the slots 101 are formed on the supporting surface 11 for respectively accommodating the terminals 30. In the instant embodiment, the insulating housing 10 further includes at least one guiding portion 12 and at least one positioning post 13, in which the guiding portion 12 and the positioning post 13 protrude from the supporting surface 11.

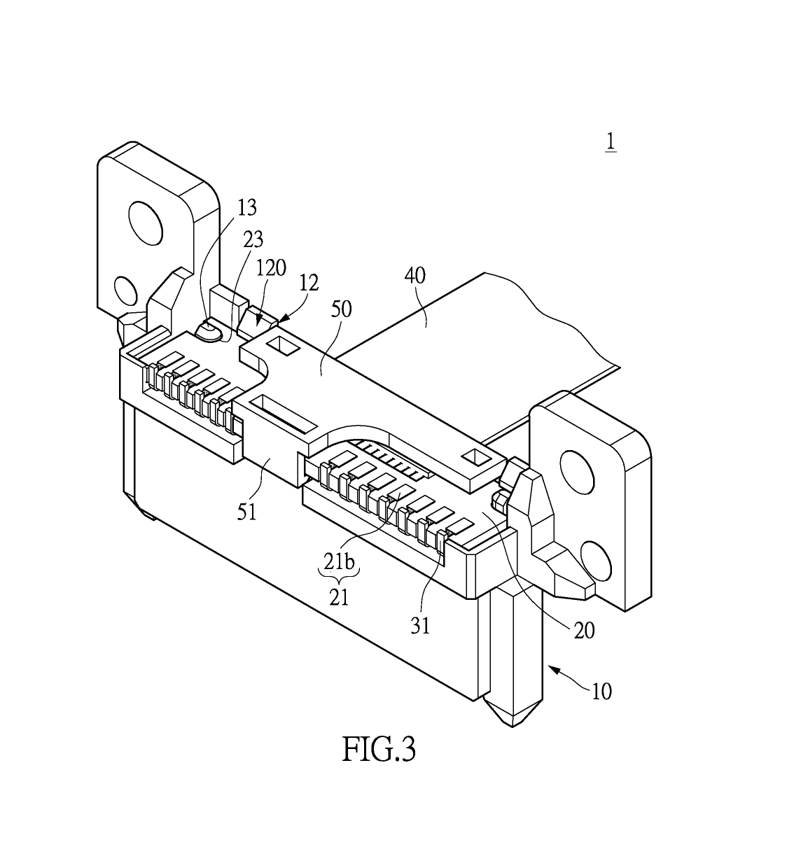

The guiding portion 12 has an inclined surface 120 and a restricting structure 121. When the adaptor board 20 is assembled on the insulating housing 10, the adaptor board 20 can slide down along the inclined surface 120 until the adaptor board is disposed on the supporting surface 11. In addition, in the instant embodiment, the restricting structure 121 is depressed relative to the inclined surface 120. Please refer to FIG. 3. FIG. 3 shows a schematic view of an electrical connector in accordance with one embodiment of the instant disclosure. When the adaptor board 20 is disposed on the supporting surface 11, the adaptor board 20 is just inserted into the depressed restricting structure 121. That is, the restricting structure 121 can hold the adaptor board 20 to prevent the adaptor board 20 from falling out due to collision. In addition, the positioning post 13 passes through the adaptor board 20 so that the adaptor board 20 can be fastened on the supporting surface 11.

Please refer to FIG. 1. The adaptor board 20 has a first surface 20a and a second surface 20b. In addition, the adaptor board 20 has a plurality of notches 200 through the adaptor board 20, a plurality of first conductive portions 21, a plurality of second conductive portions 22 and at least one positioning hole 23.

Specifically, the notches 200 are formed at one side of the adaptor board 20 and respectively correspond to the locations of the slots 101. That is, each of the notches 200 extends from the first surface 20a to the second surface 20b. The first conductive portions 21 are disposed on the adaptor board 20 respectively corresponding to the locations of the notches 200. In an embodiment of the instant disclosure, each of the first conductive portions 21 includes a contact pad 21a and an extending portion 21b. The contact pad 21a is formed on an inner surface 200a of the corresponding notch 200, and the extending portion 21b extends from an edge of the corresponding notch 200 for a distance and is formed on the first surface 20a. Notably, the extending portion 21b is an optional structure. In another embodiment, each of the first conductive portions 21 can only include the contact pad 21a formed on the inner surface 200a of the corresponding notch 200.

The second conductive portions 22 are disposed on the first surface 20a of the adaptor board 20 and electrically connected to the first conductive portions 21. In one embodiment, the electrical connections between the first and second conductive portions 21 and 22 can be established through the wiring lines embedded in the adaptor board 20 or the traces (not shown) configured on the first surface 20a or the second surface 20b.

Additionally, please refer to FIG. 1 and FIG. 3, in which FIG. 3 shows a schematic view of an electrical connector in accordance with one embodiment of the instant disclosure. The positioning hole 23 is formed on the adaptor board 20 corresponding to the positioning post 13 of the insulating housing 10. Please refer to FIG. 3. When the adaptor board 20 is disposed on the supporting surface 11, the positioning post 13 passes the adaptor board 20 through the positioning hole 23, so that the adaptor board 20 can be assembled and fastened on the insulating housing 10. In another embodiment, another fastening means or fastening structure also can be used to fix the adaptor board 20 on the insulating housing 10, and the means for fixing the adaptor board 20 are not limited to the example provided herein.

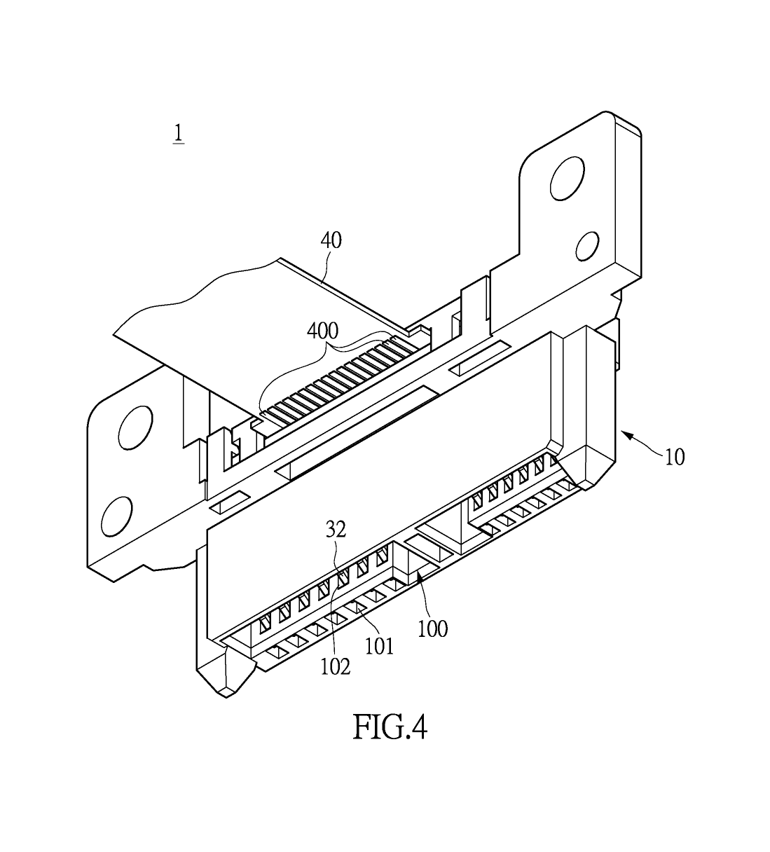

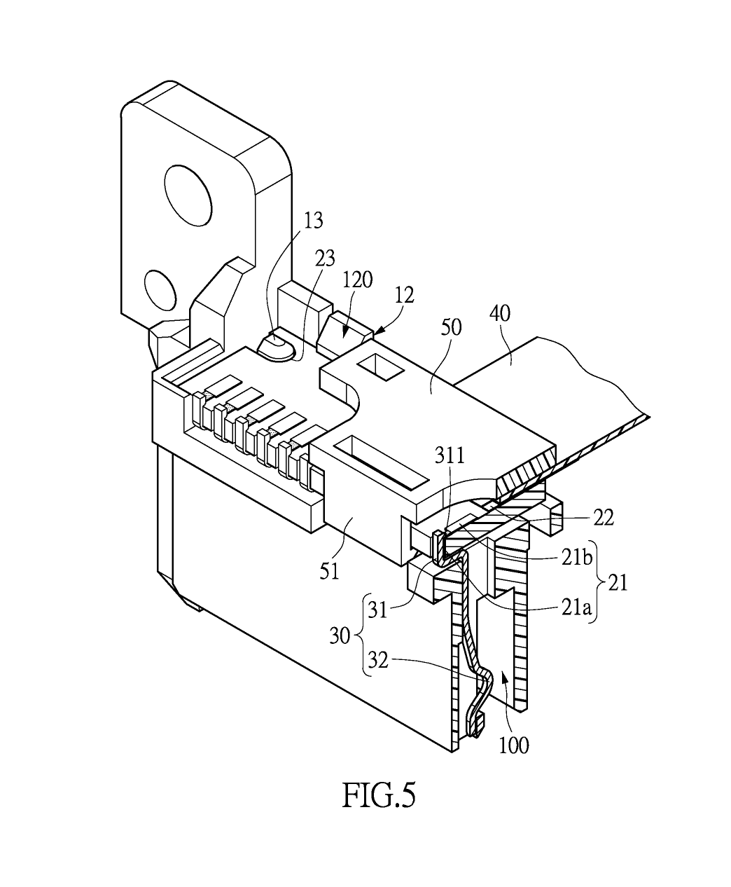

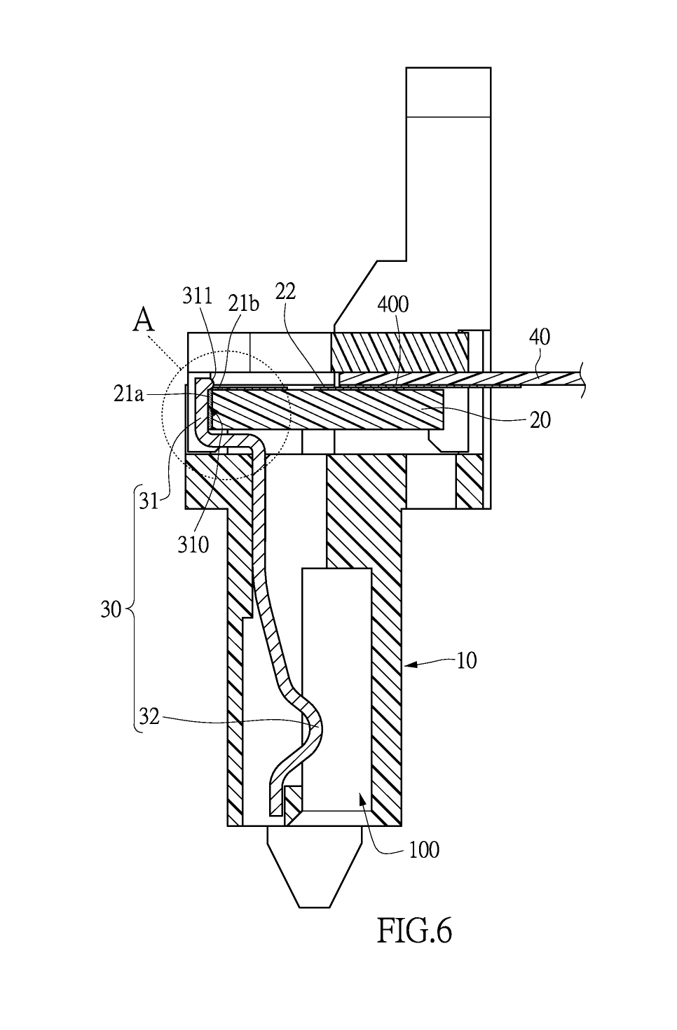

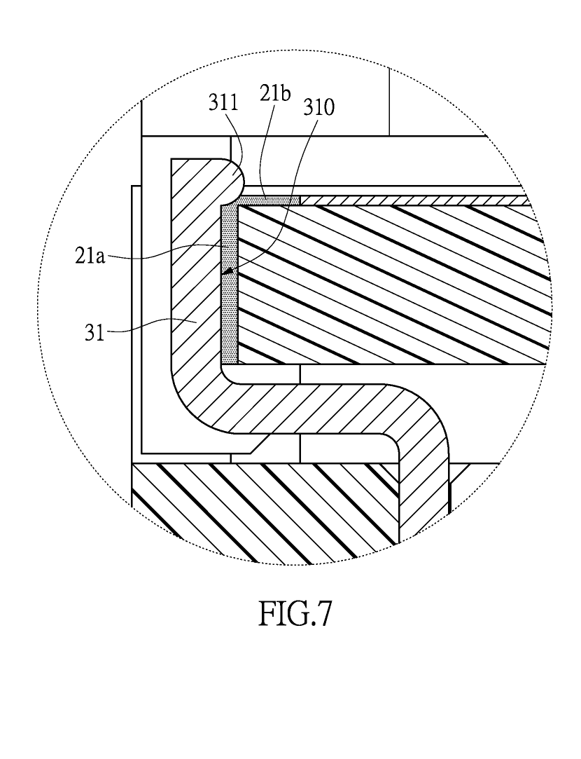

In addition, please refer to FIGS. 1 to 7. FIG. 4 shows a schematic view of an electrical connector viewed from another side in accordance with one embodiment of the instant disclosure. FIG. 5 shows a partial schematic view of an electrical connector in accordance with one embodiment of the instant disclosure. FIG. 6 shows a sectional view of an electrical connector in accordance with one embodiment of the instant disclosure. FIG. 7 shows an enlarged view of portion A shown in FIG. 6 in accordance with one embodiment of the instant disclosure.

Please refer to FIGS. 1, 3 and 4. The terminals 30 are respectively inserted into the supporting surface 11 of the insulating housing 10 and fixed in the corresponding slots 101. The terminals 30 can be made of conductive material, such as metal. Each of the terminals 30 includes an elastic portion 31 and a contacting portion 32.

Please refer to FIGS. 6 and 7. Specifically, the elastic portion 31 is of a substantial “L” shape, and has an abutting surface 310 and a protruding portion 311 protruding from the abutting surface 310. The protruding portion 311 is located at an end of the elastic portion 31. Please refer to FIG. 5. When the adaptor board 20 is assembled on the insulating housing 10, each of the elastic portions 31 of the terminals 30 is engaged with the corresponding notch 200 and electrically connected to the corresponding first conductive portion 21. That is, when the elastic portion 31 is pressed by the adaptor board 20, each of the elastic portions 31 abuts and contacts each of the contact pads 21a by the resilience force. Meanwhile, an electrical connection between each of the elastic portions 31 and the corresponding first conductive portion 21 can be established.

Further, as shown in FIG. 7, each of the elastic portions 31 of the terminals 30 abuts and contacts the contact pad 21a formed on the inner surface 200a of the notch 200 through the abutting surface 310. In addition, the protruding portion 311 protruding from the abutting surface 310 is in contact with the extending portion 21b formed on the first surface 20a of the adaptor board 20. In one preferred embodiment, for ensuring good electrical connections between each of the elastic portions 31 and the corresponding first conductive portion 21, each of the elastic portions 31 can be welded with the corresponding first conductive portion 21.

It is worth noting that when each of the elastic portions 31 of the terminals 30 is engaged with the corresponding notch 200, the adaptor board 20 can be fastened on the insulating housing 10 and each of the elastic portions 31 can be electrically connected to the corresponding first conductive portion 21 even without the welding process. Additionally, the protruding portion 311 can further assist the adaptor board 20 with positioning and ensure good electrical connections between elastic portions and the first conductive portion 21.

Additionally, please refer to FIGS. 4, 5, and 6. After each of the terminals 30 is inserted into the corresponding slot 101, each of the contacting portions 32 of the terminals 31 passes through the corresponding terminal hole 102 and protrudes from the inner sidewall of the inserting recess 100. When a plug is inserted into the inserting recess 100, the plug can be in contact with the contacting portion 32 protruding from the inner sidewall of the inserting recess 100, so that the electrical signals can be transmitted between the plug and the cable 40 through the electrical connector 1.

Please refer to FIGS. 1, 3, and 5. The cable 50 can be a flex flat cable, a flexible printed circuit or a metal wire cable. The cable 50 includes an insulating layer (not labeled) and a plurality of conductive portions 400 encapsulated by the insulating layer. The conductive portions 400 can be electrically connected to the second conductive portions 22 of the adaptor board 20 by performing an adhering process with adhesive or a welding process.

The cover 50 includes a plurality of fastening portions 51 so that the cover can be fastened on the insulating housing 10, and the cable 40 is interposed between the cover 50 and the insulating housing 10. In another embodiment, when the cover 50 is fastened on the insulating housing 10, the conductive portions 400 of the cable 40 is in contact with the second conductive portions 22 of the adaptor board 20 to establish the electrical connection.

In the electrical connector 1 of an embodiment provided in the instant disclosure, each of the elastic portions 31 of the terminals 30 can be engaged with each of notches 200 of the adaptor board 20 so that each of the elastic portions 31 can be in contact with the corresponding contact pad 21a which is disposed on the inner surface 200a of the notch 200, and thus be electrically connected to the cable 40. In addition, the conductive portions 400 of the cable 40 respectively connect the second conductive portions 22 of the adaptor board 20. Because each of the terminals 30 is engaged with the adaptor board 20 and the electrical connections between the terminals 30 and the adaptor board 20 are established through the contact pads 21a configured in the notches 200, the amount of the solder paste for forming each of the contact pads 21a can be decreased, which can result in lower parasitic capacitance or lower parasitic inductance. As such, the impact on the transmission of the high frequency signals due to the parasitic capacitance or parasitic inductance can be attenuated. Additionally, under the condition that the amount of the solder paste is decreased, good electrical connections between the terminals and the adaptor board can be ensured.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. An electrical connector, comprising:
an insulating housing, including a plurality of slots, a plurality of terminal holes, and an inserting recess, wherein the terminal holes are formed on an inner sidewall of the inserting recess;
an adaptor board, disposed on the insulating housing and having a plurality of first conductive portions, wherein the adaptor board has a plurality of notches formed at one side of the adaptor board; and
a plurality of terminals, respectively accommodated in the slots, wherein each of the terminals has an elastic portion and a contacting portion, each of the elastic portions of the terminals is engaged with each of the notches of the adaptor board and electrically connected to each of the first conductive portions, and the contacting portions of the terminals respectively pass through the terminal holes and protrude from the inner sidewall of the inserting recess.

2. The electrical connector according to claim 1, wherein each of the first conductive portions comprises a contact pad and each of the contact pads is disposed on an inner surface of each of the notches.

3. The electrical connector according to claim 2, wherein the adaptor board has a first surface and a second surface opposite to the first surface, each of the notches extends from the first surface to the second surface, and each of the elastic portions abuts the inner surface of each of the notches and is welded with the adaptor board through the corresponding contact pad.

4. The electrical connector according to claim 3, wherein each of the first conductive portions further comprises an extending portion connected to the contact pad, and the extending portion extends from an edge of the corresponding notch for a distance and is formed on the first surface.

5. The electrical connector according to claim 4, wherein each of the elastic portions is of a substantial L shape and has an abutting surface and a protruding portion protruding from the abutting surface, each of the abutting surfaces abuts each of the contact pads and each of the protruding portions is in contact with each of the extending portions.

6. The electrical connector according to claim 1, further comprising a cable electrically connected to the first conductive portions.

7. The electrical connector according to claim 6, wherein the adaptor board further comprises a plurality of second conductive portions and the cable is electrically connected to the first conductive portions through the second conductive portions.

8. The electrical connector according to claim 7, further comprising a cover, wherein the adaptor board is interposed between the cover and the insulating housing, and when the cover is fastened on the adaptor board, the cable is electrically connected to the second conductive portions of the adaptor board.

9. The electrical connector according to claim 1, wherein the insulating housing further comprises:
a supporting surface for supporting the adaptor board, wherein the supporting surface has the slots formed thereon; and
a guiding portion protruding from the supporting surface and having an inclined surface for guiding the adaptor board to be disposed on the supporting surface and a restricting structure for holding the adaptor board when the adaptor board is disposed on the supporting surface.

10. The electrical connector according to claim 9, wherein the insulating housing further comprises a positioning post protruding from the supporting surface, and the adaptor board has a positioning hole formed thereon and corresponding to the positioning post, when the adaptor board is disposed on the supporting surface, the positioning post passes the adaptor board through the positioning hole.
